(19) United States
(12) Patent Application Publication
(10) Pub. No.: US 2008/0267290 A1
(43) Pub. Date: Oct. 30, 2008

(54) Coding Method Applied to Multimedia Data

(75) Inventors: Mauro Barbieri, Eindhoven (NL); Dzevdet Burazerovic, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/599,611

(22) PCT Filed: Apr. 4, 2005
(86) PCT No.: PCT/IB05/51108

§ 371 Date: Oct. 3, 2006

(30) Foreign Application Priority Data
Apr. 8, 2004 (EP) 04300194.0

(51) Int. Cl. H04N 7/34; H04N 7/50

(52) U.S. Cl. 375/240.13; 375/240.15; 348/E07.045; 348/420.1; 375/E07.243; 375/E07.144

(57) ABSTRACT

The invention relates to a coding method applied to digital video data available in the form of a video stream consisting of consecutive frames divided into macroblocks. These frames are coded in the form of at least I-frames, coded independently, P-frames, predicted from at least a previous I- or P-frame, and B-frames, bidirectionally predicted from at least two frames between which they are disposed. According to the invention, the coding method comprises the following steps:
a structuring step, provided for capturing for all the macroblocks of the current frame related coding parameters characterizing the fact that they have been coded, or not, according to a predetermined intra prediction mode;
a computing step, for delivering statistics related to said parameters;
an analyzing step, provided for analyzing said statistics for determining the number of blocks which exhibit, or not, said intra prediction mode;
a detecting step, provided for detecting, each time said number is greater than a given threshold, the occurrence of an image, or of a sub-region of an image, which is either monochrome or with a repetitive pattern;
a description step, provided for generating description data of said occurrences of images or sub-images either monochrome or with a repetitive pattern;
a coding step, for coding both description data and original data.

### FIELD OF THE INVENTION

The invention relates to a coding method for coding digital video data available in the form of a video stream consisting of consecutive frames divided into macroblocks, said frames being coded in the form of at least I-frames, independently coded according to a coding mode said intra, or P-frames, temporally disposed between said I-frames and predicted from at least a previous I- or P-frame, or B-frames, temporally disposed between an I-frame and a P-frame, or between two P-frames, and bidirectionally predicted from at least these two frames between which they are disposed.

The invention also relates to corresponding computer-executable process steps provided to be stored on a computer-readable storage medium and comprising the steps defined in said coding method, and to a transmittable coded signal produced by encoding digital video data according to such a coding method.

### BACKGROUND OF THE INVENTION

More and more digital broadcast services are now available, and it therefore appears as useful to enable a good exploitation of multimedia information resources by users, that generally are not information technology experts. Said multimedia information generally consists of natural and synthetic audio, visual and object data, intended to be manipulated in view of operations such as streaming, compression and user interactivity, and the MPEG-4 standard is one of the most agreed solutions to provide a lot of functionalities allowing to carry out said operations. The most important aspect of MPEG-4 is the support of interactivity by the concept of object: the objects of a scene are encoded independently and stored or transmitted simultaneously in a compressed form as several bitstreams, the so-called elementary streams.

The specifications of MPEG-4 include an object description framework intended to identify and describe these elementary streams (audio, video, etc. . . . ) and to associate them in an appropriate manner in order to obtain the scene description and to construct and present to the end user a meaningful multimedia scene: MPEG-4 models multimedia data as a composition of objects, an object designating any element of an audio-visual scene. The great success of this standard however contributes to the fact that more and more information is now made available in digital form. Finding and selecting the right information becomes therefore harder, for human users as for automated systems operating on audio-visual data for any specific purpose, that both need information about the content of said information, for instance in order to take decisions in relation with said content.

The objective of the MPEG-7 standard, not yet frozen, will be to describe said content, i.e. to find a standardized way of describing multimedia material as different as speech, audio, video, still pictures, 3D models, or other ones, and also a way of describing how these elements are combined in a multimedia document. MPEG-7 is therefore intended to define a number of normative elements called descriptors D (each descriptor is able to characterize a specific feature of the content, e.g. the color of an image, the motion of an object, the title of a movie, etc. . . . ), description schemes DS (the Description Schemes define the structure and the relationships of the descriptors), description definition language DDL (intended to specify the descriptors and description schemes), and coding schemes for these descriptions. FIG. 1 gives a graphical overview of these MPEG-7 normative elements and their relation. Whether it is necessary to standardize descriptors and description schemes is still in discussion in MPEG. It seems however likely that at least a set of the most widely used will be standardized.

### SUMMARY OF THE INVENTION

It is therefore an object of the invention to propose a new descriptor intended to be very useful in relation with the MPEG-7 standard.

To this end, the invention relates to a coding method such as defined in the introductory part of the description and which is moreover characterized in that it comprises the following steps:
a structuring step, provided for capturing for all the successive macroblocks of the current frame related coding parameters characterizing the fact that they have been coded, or not, according to a predetermined intra prediction mode;
a computing step, for delivering for said current frame statistics related to said parameters;
an analyzing step, provided for analyzing said statistics for determining the number of blocks of said current frame which exhibit, or not, said intra prediction mode;
a detecting step, provided for detecting, each time said number is greater than a given threshold, the occurrence of an image, or of a sub-region of an image, which is either monochrome or with a repetitive pattern;
a description step, provided for generating description data of said occurrences of images or sub-images either monochrome or with a repetitive pattern;
a coding step, provided for encoding the description data thus obtained and the original digital video data.

Another object of the invention is to propose a set of computer-executable process steps allowing to carry out said method.

To this end, the invention relates—for a use in an encoding device provided for coding digital video data available in the form of a video stream consisting of consecutive frames divided into macroblocks, said frames being coded in the form of at least I-frames, independently coded according to a coding mode said intra, P-frames, temporally disposed between said I-frames and predicted at least from a previous I- or P-frame, and B-frames, temporally disposed between an I-frame and a P-frame, or between two P-frames, and bidirectionally predicted from at least these two frames between which they are disposed—to computer-executable process steps provided to be stored on a computer-readable storage medium and comprising the following steps:
a structuring step, provided for capturing for all the successive macroblocks of the current frame related coding parameters characterizing the fact that they have been coded, or not, according to a predetermined intra prediction mode;
a computing step, for delivering for said current frame statistics related to said parameters;
an analyzing step, provided for analyzing said statistics for determining the number of blocks of said current frame which exhibit, or not, said intra prediction mode;
a detecting step, provided for detecting, each time said number is greater than a given threshold, the occurrence of an image, or of a sub-region of an image, which is either monochrome or with a repetitive pattern;
a description step, provided for generating description data of said occurrences of images or sub-images either monochrome or with a repetitive pattern;
a coding step, provided for encoding the description data thus obtained and the original digital video data.

### BRIEF DESCRIPTION OF THE DRAWINGS

The present invention will now be described, by way of example, with reference to the accompanying drawings in which:

FIG. 1 gives a graphical overview of MPEG-7 normative elements and their relation, for defining the MPEG-7 environment in which users may then deploy other descriptors (either in the standard or, possibly, not in it);

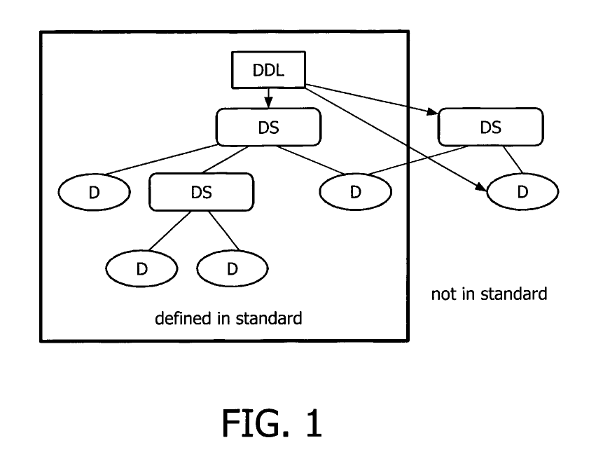

FIGS. 2 and 3 illustrate coding and decoding methods allowing to encode and decode multimedia data.

### DETAILED DESCRIPTION OF THE INVENTION

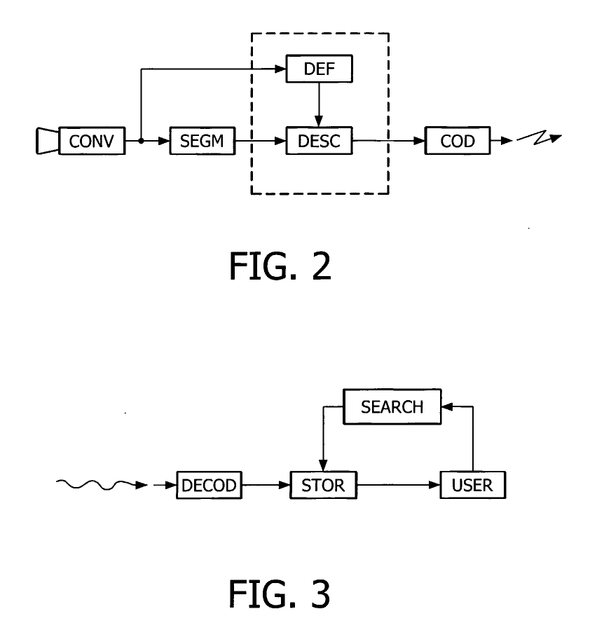

The method of coding a plurality of multimedia data according to the invention, illustrated in FIG. 2, comprises the following steps: an acquisition step (CONV), for converting the available multimedia data into one or several bitstreams, a structuring step (SEGM), for capturing the different levels of information in said bitstream(s) by means of an analysis and a segmentation, a description step, for generating description data of the obtained levels of information, and a coding step (COD), allowing to encode the description data thus obtained. More precisely, the description step comprises a defining sub-step (DEF), provided for storing a set of descriptors related to said plurality of multimedia data, and a description sub-step (DESC), for selecting the description data to be coded, in accordance with every level of information as obtained in the structuring step on the basis of the original multimedia data. The coded data are then transmitted and/or stored. The corresponding decoding method, illustrated in FIG. 3, comprises the steps of decoding (DECOD) the signal coded by means of the coding method hereinabove described, storing (STOR) the decoded signal thus obtained, searching (SEARCH) among the data constituted by said decoded signal, on the basis of a search command sent by an user (USER), and sending back to said user the retrieval result of said search in the stored data.

Among the descriptors stored in relation with all the possible multimedia content, the one proposed according to the invention is based on the future standard H.264/AVC, which was expected to be officially approved in 2003 by ITU-T as Recommendation H.264/AVC and by ISO/IEC as International Standard 14496-10 (MPEG-4 Part 10) Advanced Video Coding (AVC). This new standard employs quite the same principles of block-based motion-compensated transform coding that are known from the established standards such as MPEG-2. The H.264 syntax is, therefore, organized as the usual hierarchy of headers (such as picture-, slice- and macroblock headers) and data (such as motion vectors, block-transform coefficients, quantizer scale, etc). While most of the known concepts related to data structuring (e.g. I, P, or B pictures, intra- and inter macroblocks) are maintained, some new concepts are also introduced at both the header and the data level. Mainly H.264/AVC separates the Video Coding Layer (VCL), which is defined to efficiently represent the content of the video data, and the Network Abstraction Layer (NAL), which formats data and provides header information in a manner appropriate for conveyance by the higher level (transport) system.

One of the main particularities of H.264/AVC at the data level is also the use of more elaborate partitioning and manipulation of 16×16 macroblocks (a macroblock MB includes both a 16×16 block of luminance and the corresponding 8×8 blocks of chrominance, but many operations, e.g. motion estimation, actually take only the luminance and project the results on the chrominance). So, the motion compensation process can form segmentations of a MB as small as 4×4 in size, using motion vector accuracy of up to one-fourth of a sample grid. Also, the selection process for motion compensated prediction of a sample block can involve a number of stored previously decoded pictures, instead of only the adjoining ones. Even with intra coding, it is now possible to form a prediction of a block using previously decoded samples from neighboring blocks (the rules for this spatial-based prediction are described by the so-called intra prediction modes). This aspect is especially relevant for the invention here defined and will be highlighted later in the description. After either motion compensated- or spatial-based prediction, the resulting prediction error is normally transformed and quantized based on 4×4 block size, instead of the traditional 8×8 size. The H.264/AVC standard still uses other specific realizations in other coding stages (e.g. entropy coding), most of which are fixed or can only be altered at or above the picture level.

As it was the case with the previous standards, H.264/AVC allows an image block to be coded in intra mode, i.e. without the use of a temporal prediction from the adjacent images. A novelty of H.264/AVC intra coding is the use of a spatial prediction, allowing to predict an intra block by a block P formed from previously encoded and reconstructed samples in the same picture. This prediction block P will be subtracted from the actual image block prior to encoding, which is different from the existing standards (e.g. MPEG-2, MPEG-4 ASP) where the actual image block is encoded directly. The choice of the intra mode must be signaled to the decoder, for which purpose H.264 defines an efficient encoding procedure (the central idea is to avoid separate encoding of the 4×4 modes, by exploiting the observation that the modes of neighboring 4×4 blocks will often be highly correlated).

Recent advances in computing, communications and digital data storage have led in both the professional and the consumer environment, to a tremendous growth of large digital archives, characterized by a steadily increasing capacity and content variety. Finding efficient ways to quickly retrieve stored information of interest is therefore of crucial importance. Since searching manually through terabytes of unorganized stored data is tedious and time consuming, there is a growing need to transfer information search and retrieval tasks to automated systems. Search and retrieval in large archives of unstructured video content is usually performed after the content has been indexed using content analysis techniques. These techniques comprise algorithms that aim at automatically creating, in view of the description of the video content, annotations of video material (such annotations vary from low-level signal related properties such as color and texture to higher-level information such as presence and location of faces).

An important content descriptor is the so-called monochrome, or “unicolour” frame indicator. A frame is considered as monochrome if it is totally filled with the same color (in practice, because of noise in the signal chain from production to delivery, a monochrome frame often presents imperceptible variations of one single color, e.g. blue, dark gray or black). Detecting monochrome frames is an important step in many content-based retrieval applications. For instance, as described in the Patent Application Publication US2002/0186768, commercial detectors and program boundaries detectors rely on the identification of the presence of monochrome frames, usually black, that are inserted by broadcasters to separate two successive programs or a program from commercial advertisements. Monochrome frame detection is also used for filtering out uninformative keyframes from a visual table of content.

Because of the large application area for the upcoming H.264/MPEG-4 AVC standard, there will be a growing demand for efficient solutions for H.264/AVC video content analysis. During the recent years, several efficient content analysis algorithms and methods have been demonstrated for MPEG-2 video, that almost exclusively operate in the compressed domain. Most of these methods could be extended to H.264/AVC, since H.264/AVC in a way specifies a superset of MPEG-2 syntax, as seen above. However, due to the limitations of MPEG-2, some of these existing methods may not give adequate or reliable performance, which is a deficiency that is typically addressed by including additional and often costly methods operating in the pixel or audio domain.

A European patent application filed on Apr. 8, 2004, with the official filing number 04300189.0 (PHFR040040) then proposes a method allowing to avoid said drawback. More precisely, said European patent application relates to a detection method (and the corresponding detection device) applied to digital coded video data available in the form of a video stream comprising consecutive frames divided into macroblocks themselves subdivided into contiguous blocks, said frames including at least I-frames, coded independently of any other frame either directly or by means of a spatial prediction from at least a block formed from previously encoded and reconstructed samples in the same frame, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed, said detection method moreover comprising the steps of:
determining for each successive block of the current frame if it has been coded, or not, according to a predetermined intra prediction mode;
collecting similar information for all the successive blocks of the current frame, for delivering statistics related to said predetermined intra prediction mode;
analyzing said statistics for determining the number of blocks of said current frame which exhibit, or not, said intra prediction mode;
a detecting step, provided for detecting, each time said number is greater than a given threshold, the occurrence of an image, or of a sub-region of an image, which is either monochrome or with a repetitive pattern.

The principle of the technical solution described in said European patent application is based on the fact that intra prediction modes, which are innovative coding tools of H.264/AVC, can be conveniently used for the purpose of monochrome frame detection. The main idea is to observe the distribution of intra prediction mode for macro-blocks constituting an image. A monochrome image or sub-image is detected when most of the blocks exhibit same or similar prediction mode: the number of such blocks can for instance be compared with a fixed threshold. When most of the blocks in the image (or sub-image) are encoded according to a certain intra prediction mode, the image (or sub-image) presents very low spatial variation, and it is either monochrome or contains a repetitive pattern (for the earlier mentioned application of this algorithm to the generation of the table of content or for keyframe extraction, both types of images or sub-images—monochrome and with a repetitive pattern—have to be discarded).

According to the MPEG-7 standard draft ISO/IEC 1/SC 29 N 4242 (Oct. 23, 2001), tools are specified for describing the features of multimedia content, inter alia the descriptors D and the description schemes DS.

A definition of the coding method according to the invention is then the following. The digital video data to be coded are available in the form of a video stream comprising consecutive frames divided into macroblocks themselves subdivided into contiguous blocks, and said frames are coded in the form of at least I-frames, independently coded according to a coding mode said intra, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed. The coding method moreover comprises the following steps:
a structuring step, provided for capturing, for all the successive blocks of the current frame, related coding parameters characterizing the fact that they have been coded, or not, according to a predetermined intra prediction mode;
a computing step, for delivering, for said current frame, statistics related to said parameters;
an analyzing step, provided for analyzing said statistics and for determining the number of blocks of said current frame which exhibit, or not, said intra prediction mode;
a detecting step, provided for detecting, each time said number is greater than a given threshold, the occurrence of an image, or of a sub-region of an image, which is either monochrome or with a repetitive pattern;
a description step, provided for generating description data of said occurrences of images or sub-images either monochrome or with a repetitive pattern;
the coding step itself, provided for encoding the description data thus obtained and the original digital video data.

These steps can be implemented, according to the invention, by means of an encoding device for coding digital video data available in the form of a video stream comprising consecutive frames divided into macroblocks themselves subdivided into contiguous blocks, said frames being coded in the form of at least I-frames, independently coded according to a coding mode said intra, P-frames, temporally disposed between said I-frames and predicted at least from a previous I- or P-frame, and B-frames, temporally disposed between an I-frame and a P-frame, or between two P-frames, and bidirectionally predicted from at least these two frames between which they are disposed, said encoding device comprising:
structuring means, provided for capturing, for all the successive macroblocks of the current frame, related coding parameters characterizing the fact that they have been coded, or not, according to a predetermined intra prediction mode;
a computing step, for delivering, for said current frame, statistics related to said parameters;
an analyzing step, provided for analyzing said statistics and for determining the number of blocks of said current frame which exhibit, or not, said intra prediction mode;
a detecting step, provided for detecting, each time said number is greater than a given threshold, the occurrence of an image, or of a sub-region of an image, which is either monochrome or with a repetitive pattern;
a description step, provided for generating description data of said occurrences of images or sub-images either monochrome or with a repetitive pattern;
a coding step, provided for encoding the description data thus obtained and the original digital video data.

The steps of the coding method according to the invention can also be implemented by means of computer-executable process steps stored on a computer-readable storage medium and comprising similarly the steps of:
capturing for all the successive macroblocks of the current frame related coding parameters characterizing the fact that they have been coded, or not, according to a predetermined intra prediction mode;
delivering for said current frame statistics related to said parameters
analyzing these statistics for determining the number of blocks of said current frame which exhibit, or not, said intra prediction mode;
detecting, each time said number is greater than a given threshold, the occurrence of an image, or of a sub-region of an image, which is either monochrome or with a repetitive pattern;
   these steps being followed by a description step, provided for generating description data of said occurrences of images or sub-images, and an associated coding step, provided for encoding the description data thus obtained and the original digital video data.

The invention still relates to a transmittable coded signal such as the one available at the output of said encoding device and produced by encoding digital video data according to the coding method previously described.

It must be indicated here that the present invention is not limited to the afore-mentioned embodiment, and variations and modifications may be made without departing from the spirit and scope of the invention as defined in the appended claims.

It can be noted, for instance, that the words “macroblock” and “block” used in the specification or the claims are not only intended to describe the hierarchy of the rectangular sub-regions of a frame, as used in standards such as MPEG-2 or MPEG-4 for example, but also any kind of arbitrarily shaped sub-regions of a frame, as encountered in encoding or decoding schemes based on irregularly shaped blocks.

It must be noted, also, that there are numerous ways of implementing functions by means of items of hardware or software, or both. In this respect, the drawings are very diagrammatic and, when a drawing shows different functions as different blocks, this by no means excludes that a single item of hardware or software carries out several functions. Nor does it exclude that an assembly of items of hardware or software or both carry out a function.

It can still be indicated that the word “comprising” does not exclude the presence of other elements or steps than those listed in a claim. The word “a” or “an” preceding an element or step does not exclude the presence of a plurality of such elements or steps.

1. A coding method for coding digital video data available in the form of a video stream comprising consecutive frames divided into macroblocks themselves subdivided into contiguous blocks, said frames being coded in the form of at least I-frames, independently coded according to a coding mode said intra, P-frames, temporally disposed between said I-frames and predicted from at least a previous I- or P-frame, and B-frames, temporally disposed between an I-frame and a P-frame, or between two P-frames, and bidirectionally predicted from at least these two frames between which they are disposed, said coding method comprising the following steps:
a structuring step, provided for capturing, for all the successive macroblocks of the current frame, related coding parameters characterizing the fact that they have been coded, or not, according to a predetermined intra prediction mode;
a computing step, for delivering, for said current frame, statistics related to said parameters;
an analyzing step, provided for analyzing said statistics and for determining the number of blocks of said current frame which exhibit, or not, said intra prediction mode;
a detecting step, provided for detecting, each time said number is greater than a given threshold, the occurrence of an image, or of a sub-region of an image, which is either monochrome or with a repetitive pattern;
a description step, provided for generating description data of said occurrences of images or sub-images either monochrome or with a repetitive pattern;
a coding step, provided for encoding the description data thus obtained and the original digital video data.

2. An encoding device for coding digital video data available in the form of a video stream comprising consecutive frames divided into macroblocks themselves subdivided into contiguous blocks, said frames being coded in the form of at least I-frames, independently coded according to a coding mode said intra, P-frames, temporally disposed between said I-frames and predicted at least from a previous I- or P-frame, and B-frames, temporally disposed between an I-frame and a P-frame, or between two P-frames, and bidirectionally predicted from at least these two frames between which they are disposed, said encoding device comprising:
structuring means, provided for capturing, for all the successive macroblocks of the current frame, related coding parameters characterizing the fact that they have been coded, or not, according to a predetermined intra prediction mode;
computing means, for delivering, for said current frame, statistics related to said parameters
analyzing means, provided for analyzing said statistics and for determining the number of blocks of said current frame which exhibit, or not, said intra prediction mode;
detecting means, provided for detecting, each time said number is greater than a given threshold, the occurrence of an image, or of a sub-region of an image, which is either monochrome or with a repetitive pattern;
description means, provided for generating description data of said occurrences of images or sub-images either monochrome or with a repetitive pattern;
coding means, provided for encoding the description data thus obtained and the original digital video data.

3. For use in an encoding device for coding digital video data available in the form of a video stream comprising consecutive frames divided into macroblocks themselves subdivided into contiguous blocks, said frames being coded in the form of at least I-frames, independently coded according to a coding mode said intra, P-frames, temporally disposed between said I-frames and predicted at least from a previous I- or P-frame, and B-frames, temporally disposed between an I-frame and a P-frame, or between two P-frames, and bidirectionally predicted from at least these two frames between which they are disposed, said encoding device comprising:
structuring means, provided for capturing, for all the successive macroblocks of the current frame, related coding parameters characterizing the fact that they have been coded, or not, according to a predetermined intra prediction mode;
computing means, for delivering, for said current frame, statistics related to said parameters;
analyzing means, provided for analyzing said statistics and for determining the number of blocks of said current frame which exhibit, or not, said intra prediction mode;
detecting means, provided for detecting, each time said number is greater than a given threshold, the occurrence of an image, or of a sub-region of an image, which is either monochrome or with a repetitive pattern;
description means, provided for generating description data of said occurrences of images or sub-images either monochrome or with a repetitive pattern;
coding means, provided for encoding the description data thus obtained and the original digital video data.

4. A computer program product for a digital video data coding device, comprising a set of instructions which when loaded into said coding device lead it to carry out the steps as claimed in claim 3.

5. A transmittable coded signal produced by encoding digital video data according to a coding method as claimed in claim 1.
